(19) United States
(12) Patent Application Publication
(10) Pub. No.: US 2001/0049640 A1
(43) Pub. Date: Dec. 6, 2001

(54) Image print order system using network, digital image data recording medium, and providing method thereof

(76) Inventors: Toru Kurokawa, Tokyo (JP); Yojiro Yamashita, Tokyo (JP); Shigekazu Fukada, Tokyo (JP)

Correspondence Address: BIRCH STEWART KOLASCH & BIRCH, PO BOX 747, FALLS CHURCH, VA, 22040-0747, US

(21) Appl. No.: 09/870,475

(22) Filed: Jun. 1, 2001

(30) Foreign Application Priority Data
Jun. 2, 2000 (JP) P.2000-165999

(51) Int. Cl. G06F 17/60

(52) U.S. Cl. 705/26

(57) ABSTRACT

Print service receiving servers 2-1 and 2-2 are connected to a network 1. A user, in case of requesting print of digital image data recorded on a recording medium 5, mounts the recording medium 5 onto a terminal 4. On the recording medium 5, connection address data to the specified server (for example, server 2-1) and data indicating the specified service shop (for example, service shop 3-1) are recorded. When the recording medium 5 is mounted, the terminal 4 connects through the network 1 to the server 2-1 and transmits print request data (service shop data, requester, the requested number of prints and the like) together with the digital image data to be printed, and the server 2-1 sends other data than the service shop data to a service shop 3-1.

### BACKGROUND OF THE INVENTION

1. Field of the Invention

The present invention relates to an image print order system using a network, a recording medium on which digital image data have been recorded, and a recording medium providing method. Particularly, it relates to an order system that can specify a receiver of an order readily when an image print is ordered using a network, a recording medium fit for such an order, and a method for providing such a recording medium.

2. Description of the Related Art

By the quick spread of a digital camera in addition to the spread and multimedia processing of a personal computer, the environment where digital photographic image can be handled in home is being created. Correspondingly, the convenience of additional application (image processing, editing, arrangement, saving, image mail communication, commonage by network, and the like) by digitization of a photographic image is recognized, so that a service of digitizing an image obtained by a silver bromide film (image of a negative film, a reversal film, or a photographic print) is also provided.

A summary of a service of digitizing an image will be described with reference to FIG. 6. A service shop 10 performs a service of keeping various kinds of input mediums 20 on which images have been recorded and providing an output medium 30 on which digital image data have been recorded. The input mediums are non-developed film 21, an already-developed film 22, a photographic print 23, a recording medium for digital camera (memory card) 24, and the like. The non-developed film 21, after developing, is digitized by a scanner or the like, and the already-developed film 22 and the photographic print 23 are intactly digitized by the scanner or the like. These digital data 11 and digital data of the memory card 12 are subjected to the necessary image processing 13 (various correction, conversion of data type, file conversion, and the like), and recorded on a CD-R, a DVD, or the like as an output medium 30. At this time, a viewer program of the image may be additionally recorded. The service shop 10 may perform all these processing, may request a part (development or the like) or all of the processing to another service shop to perform only a part by itself, or may only act as an agency.

The thus provided recording medium is utilized and kept by a user. In case that he would like to print the recorded photographic image, it was necessary for him to bring the recording medium into the service shop for print service and to request print (to print the photographic image by himself in case that an automatic printing machine is set in the shop).

Further, though print service through a network is also performed, setting of an order server, a print receiving method, setting of a receiving shop, and the like were not easy.

### SUMMARY OF THE INVENTION

An object of the invention is to provide an image print order system in which a print order can be easily performed using a network. Another object is to provide a recording medium in which a print order can be easily performed and a providing method of the recording medium.

In order to solve the above problems, according to the invention, on a recording medium on which digital image data have been recorded, data for automatically connecting to an order receiving server when the recording medium is mounted to a terminal and designated print-order acceptant information are previously recorded.

Further, as the designated print-order acceptant information, data for specifying a request receiver to whom creation of the recording medium is requested is previously recorded.

### BRIEF DESCRIPTION OF THE DRAWINGS

FIG. 1 is a diagram showing the schematic constitution of an image print order system of the invention.

FIG. 2 is a flowchart of print order.

FIG. 3 is diagram showing an example of a displayed page in case that the order cannot be received.

FIG. 4 is a diagram showing an example of a displayed page of a print order receiving shop list.

FIG. 5 is a diagram showing an example of a displayed order-receiving page.

FIG. 6 is a diagram showing a summary of image digitizing service.

### DESCRIPTION OF THE PREFERRED EMBODIMENTS

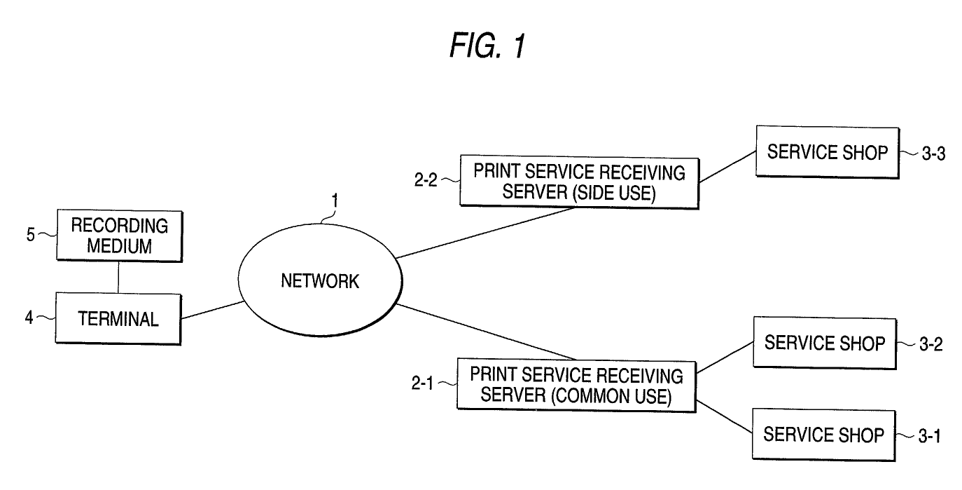

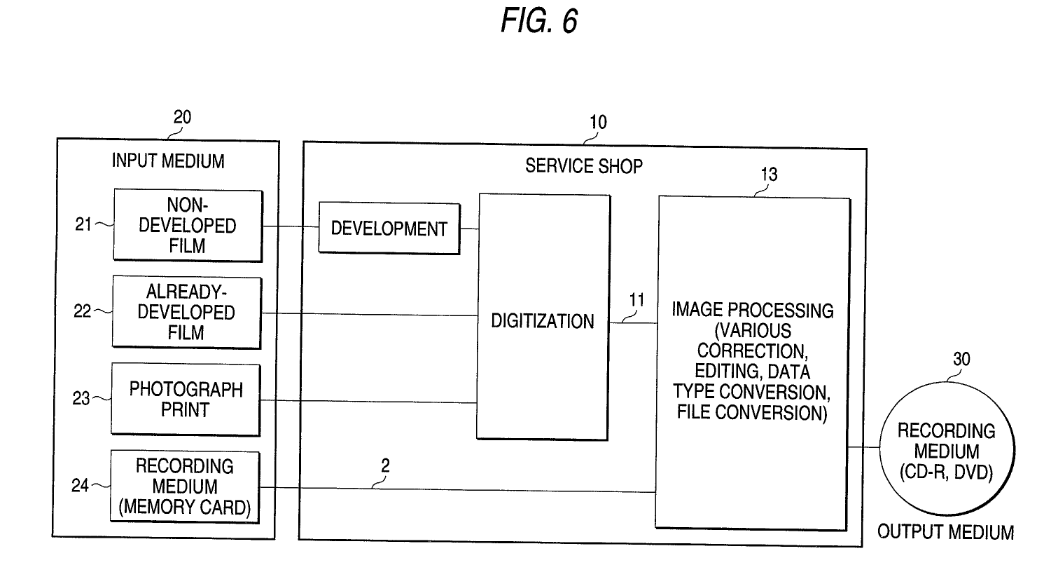

A mode for carrying out the invention will be described below with reference to FIGS. 1 to 6.

FIG. 1 is a diagram showing a schematic constitution of an image print order system according to the invention.

To a network 1 such as an Internet or the like, print service receiving servers 2-1 and 2-2 are connected. In case that a user requires print of digital image data recorded on a recording medium 5, he mounts the recording medium 5 to a terminal 4. Connection address data to a specified server and data indicating a specified service shop where print is ordered have been recorded on the recording medium 5. Now, assuming that data indicating the print service receiving server 2-1 and a service shop 3-1 has been recorded, the terminal 4 connects through the network 1 to the print service receiving server 2-1 and transmits print request data (requested service shop data, requester, the requested number of prints, and the like) together with digital image data to be printed. The server 2-1 transmits the reception data to the service shop 3-1. In case that the service shop 3-1 is simply an agency, the server 2-1 transmits the reception data to another service shop (not shown) to request print and delivery to the service shop 3-1, and it transmits reception of the print order to the service shop 3-1. The user who has requested the print can get the photographic print at the service shop 3-1 after a predetermined time.

Next, a recording medium proving method of the invention, the constitution of the recording medium, and a print ordering method will be described in detail. In the following description, the recording medium 5 is taken as a CD-R and the print service-receiving servers 2-1, 2-2 are taken as WWW servers.

The print service-receiving server 2-1 has a print order receiving WWW page for each of the plural service shops 3-1, 3-2, and the print service-receiving server 2-2 has a print order receiving WWW page for the service shop 3-3. A chain store and a small-scale independent service shop are suited to a mode of the print service receiving server 2-1 and the plural service shops 3-1, 3-2. In case that the independent service shop can hold an independent server, it is suited to a mode of the print service receiving server 2-2 and the service shop 3-3. In case that the user brings a non-developed film into the service shop 31 to request development processing and recording to a CD-R, similarly to the conventional example, the service shop 3-1 performs the development processing, digitization processing, and image processing, using equipments in its shop or external equipments, and records on the CD-R digital image data and a thumbnail image as an index of the recorded images. At this time, on the CD-R, a URL of a print order receiving WWW page of its own shop, an automatic run program, and a to-network connection processing program operated by the automatic run program are recorded together with the image data. Additionally, a viewer program of image, an order receiving data creating program, user's name and telephone number, and the like may be recorded.

When the user mounts the CD-R received from the service shop 3-1 to the terminal 4, a picture for selecting image display by a viewer program (which may be what has been recorded on the CD-R or what has been previously recorded in the terminal) or print order is displayed by the automatic run program.

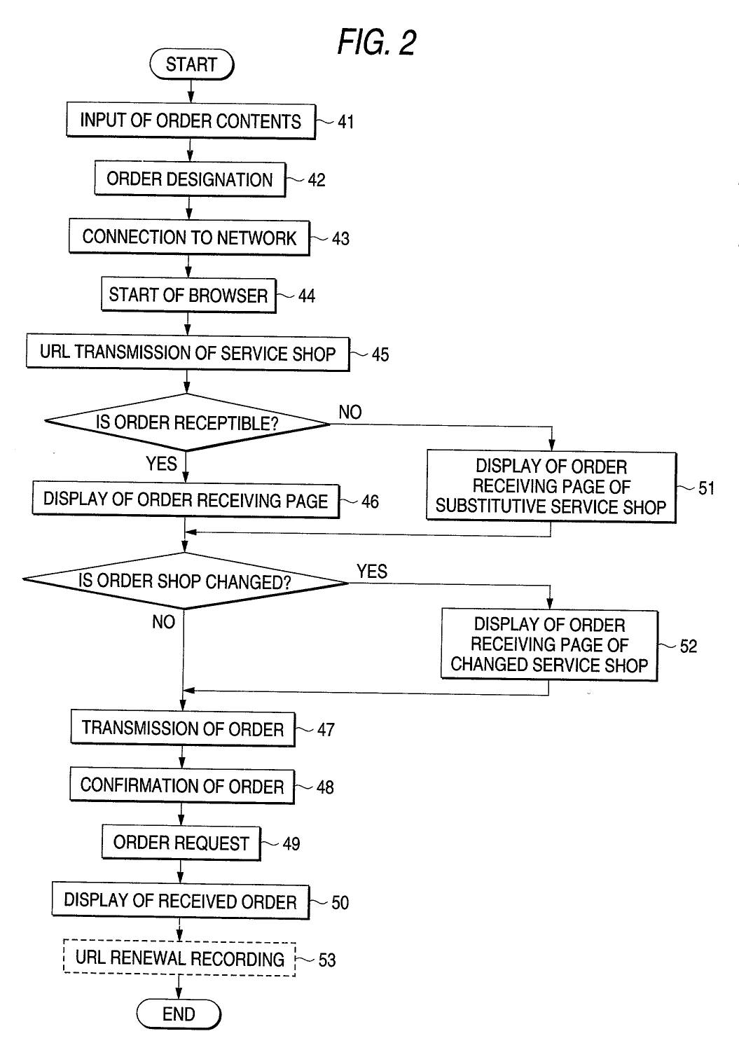

A flowchart in case that the print order is selected is shown in FIG. 2. In case that the print order is selected, the process proceeds to an input processing of the order contents (step 41). The input processing of the order contents comprises input of an image to be printed, input of print condition (print size, the number of prints, special processing and the like), input of order requester's name and telephone number, selection of a paying method, and the like.

The image to be printed can be input readily by displaying the thumbnail image of the images recorded on the CD-R and selecting the necessary image. In case that the user requests print of other images than the images recorded on the CD-R, image data of another memory to which the terminal can access is selected. The print condition is also input similarly.

Though order requester's name and telephone number may be input at the ordering time, they may be previously input at the creating time of the CD-R to be utilized. The paying method may be also input similarly. A program for these input processing may be previously recorded on the CD-R or may be recorded in the terminal.

When the input of the order contents is completed, a button on the screen is clicked thereby to input order instruction (step 42). By this instruction, connection processing to the network is performed (step 43). In case that the terminal connects to the network by dial-up connection, a connection program (which is usually installed in the terminal) is started, the terminal connects to an access point by a telephone circuit or an ISDN circuit, and a user ID and a password are input to perform connection. The telephone number of the access point, the user ID and the password, in case that the terminal is a private terminal of the user such as a family personal computer, may be previously stored in the terminal.

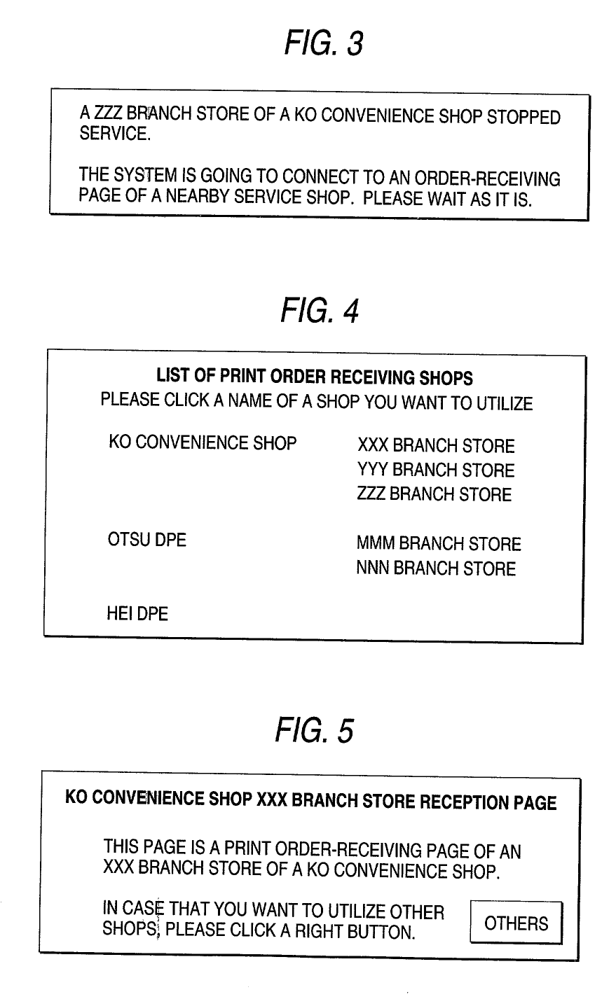

Next, a browser program of the terminal is started (step 44), a URL of an order inputting WWW page of the service shop 3-1 is transmitted (step 45), and an order receiving page is obtained and displayed (step 46). In case that the service shop cannot receive the order since it is closed or is under refit, a page as shown in FIG. 3 is displayed and thereafter an order receiving page of a substitute service shop is displayed (step 51). As a substitute service shop, a nearby service shop is previously set. And, the already-input order contents are transmitted as order data (step 47).

In case that the user wants to receive the print from another service shop than the service shop 3-1, a print order receiving shop list page as shown in FIG. 4 is displayed. After an order receiving page of another service shop was obtained and displayed (step 52), the already-input order contents are transmitted as order data (step 47). The order-receiving page includes a button of utilizing another shop as shown in FIG. 5. By clicking this button, page data shown in FIG. 4 can be obtained.

In this example, after the connection to the network, the browser is started. However, before the connection to the network, the browser may be started. Further, after input of the order contents, the connection to the network is performed. However, the connection to the network may be firstly performed and thereafter the order contents may be input on the order-receiving page. In this case, an order content input processing program can be supplied from the server. Further, in case that the service shop 3-1 cannot receive the order, instead of displaying the order receiving page of the substitute service shop, this system may display the page of the print order receiving shop list as shown in FIG. 4 to select the service shop that receives the order.

When the order data is transmitted to the server 2-1, a calculation of an amount of money according to the print processing contents, a service shop that receives the print, a receptible data, and the like are displayed and their confirmation is demanded (step 48). In case that there are no errors, the user clicks the button on the screen to input an order request (step 49).

When the order request is transmitted to the server 2-1 (another server in case that another receiving shop is designated), a signal indicating the reception of the order request is transmitted from the server 2-1 and displayed on the terminal (step 50). In this displayed picture, a reception number and the like are included as display data. This data is printed out or the reception number is written down thereby to use this data for the order reception in the service shop 2-1.

In case that another reception shop is designated, the URL recorded on the recording medium 5 may be rewritten (step 53).

As clear from the above description, according to the invention, connection to the network order server can be automatically performed, and a service shop to which recording medium creation is requested is automatically selected as a service shop to which print is requested. Therefore, an order using a network can be performed lightheartedly and readily.

What is claimed is:

1. An image print order system using a network, comprising:
an order receiving server which is connected to said network, and
a terminal unit connectable to said network, to which a recording medium can be mounted, wherein
said terminal unit, when the recording medium, storing a digital image data, a server-connection address information, and a designated print-order acceptant information, is mounted to the terminal unit, said terminal unit is connected to said order receiving server based on said server-connection address information so as to transmit said designated print-order acceptance information and at least a part of said digital image data to said order receiving server; and further wherein
said order receiving server outputs a print command data based on the received digital image data, and a command data by which an acceptant of an order in accordance with said designated print-order acceptant information can receive an image print that is printed based on said print command data.

2. An image print order system according to claim 1, wherein said order receiving server is a WWW server.

3. An image print order system according to claim 2, wherein said server-connection address information and designated print-order acceptant information are recorded on said recording medium as URL data for specifying a WWW page created for each receiver of the order, and
said terminal unit, after acquiring the data of the WWW page for each of said specified receivers of the order, transmits said digital image data to said WWW server.

4. An image print order system according to claim 3, wherein the data of the WWW page for each of said specified receivers of the order includes data for acquiring data of a WWW page of another receiver than the receiver of the order according to said designated print-order acceptant information.

5. An image print order system according to claim 3, wherein said terminal unit, when the receiver of the order according to said designated print-order acceptant information cannot receive the order, obtains a WW page of a substitutive receiver of the order or a WWW page including order-receivable-receiver data.

6. An image print order system according to any one of claims 1 to 5, wherein said order receiving server, when said terminal unit, when the receiver of the order according to said designated print-order acceptant information cannot receive the order, or by selection of an order requester, outputs command data for making it possible that another receiver than the receiver of the order according to said designated print-order acceptant information receives said image print.

7. An image print order system according to any one of claims 1 to 5, wherein said server-connection address information and designated print-order acceptant information are recorded when the digital image data is recorded in said recording medium.

8. An image print order system according to any one of claims 1 to 5, wherein said designated print-order acceptant information is data that specifies a receiver of request to whom creation of said recording medium has been requested.

9. An image print order system according to any one of claims 1 to 5, wherein said server-connection address information and said designated print-order acceptant information are renewable.

10. A recording medium on which digital image data has been recorded, which can be mounted to a terminal unit connectable to a network, and which stores therein connection address data to a print order receiving server connected to said network, designated print-order acceptant information, and data for causing said terminal unit to connect to said order receiving server through said network when the recording medium is mounted to said terminal unit and to transmit said designated print-order acceptant information to said order receiving server.

11. A recording medium according to claim 10, wherein said order receiving server is a WWW server.

12. A recording medium according to claim 11, wherein said server-connection address information and designated print-order acceptant information are URL data for specifying a WWW page created for each receiver of the order.

13. A recording medium according to any one of claims 10 to 12, wherein said server-connection address information and designated print-order acceptant information are recorded when the digital image data is recorded in said recording medium.

14. A recording medium according to any one of claims 10 to 12, wherein said designated print-order acceptant information is data that specifies a receiver of request to whom creation of said recording medium has been requested.

15. A recording medium according to any one of claims 10 to 12, wherein said server-connection address information and said designated print-order acceptant information are renewable.

16. A recording medium providing method for providing a recording medium on which digital image data have been recorded, wherein
at least one of digital image data obtained by developing a photographic film before development and carrying out a photoelectrical conversion of the image after development, digital image data obtained by carrying out a photoelectrical conversion of the photographic film after development or an image of an image print, and digital image data recorded on other recording mediums is recorded on a single recording medium, and
there is included a step of recording connection address data to a print order receiving server connected to a network, designated print-order acceptant information, and data for causing said terminal unit to connect to said order receiving server through said network when the recording medium is mounted to a terminal unit and to transmit said designated print-order acceptant information to said order receiving server.

17. A recording medium providing method according to claim 16, wherein said order receiving server is a WWW server.

18. A recording medium providing method according to claim 17, wherein said server-connection address information and designated print-order acceptant information are recorded on said recording medium as URL data for specifying a WWW page created for each receiver.

19. A recording medium providing method according to any one of claims 16 to 18, wherein said designated print-order acceptant information is data that specifies a provider to whom provision of said recording medium is requested.
